(19) United States
(12) Patent Application Publication
(10) Pub. No.: US 2009/0217271 A1
(43) Pub. Date: Aug. 27, 2009

(54) METHOD AND APPARATUS FOR MANAGING DATA

(75) Inventor: Satoru GOTO, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Buffalo Inc., Nagoya-shi (JP)

(21) Appl. No.: 12/390,821

(22) Filed: Feb. 23, 2009

(30) Foreign Application Priority Data
Feb. 26, 2008 (JP) 2008-045013

(51) Int. Cl. G06F 17/30; G06F 9/46

(52) U.S. Cl. 718/100; 707/201

(57) ABSTRACT

A method and apparatus for managing data by a computer capable of selecting a storage destination of a file from a plurality of drives including a first drive and a second drive are provided. The method includes: editing a target file in the first drive in accordance with an input from a user; listing one or more tasks as unprocessed tasks to be processed on a task list, each of the one or more tasks comprising a content of an edit applied to the target file in association with a name of the target file; and creating a copy of the target file in the second drive by sequentially processing the unprocessed tasks listed on the task list independently of a flow of editing the target file.

### CROSS-REFERENCE TO RELATED APPLICATIONS

This application is based on and claims the priority from Japanese Patent Application No. 2008-045013 filed on Feb. 26, 2008, the entire contents of which are incorporated herein by reference.

### TECHNICAL FIELD

The present invention relates to a method and apparatus for managing data by a computer that can select a storage destination from a plurality of drives.

### BACKGROUND

In order to improve a fault tolerance of data, it is recommended that a user creates a backup of the data and saves it every time he or she accesses the data. As the storage destinations of the backup, for example, there are a hard disk built in a computer, a USB memory detachably attached to a computer, an external storage that can communicate with a computer by radio or cable through a network.

As an example of such external storage, there exists a network attached storage (NAS). An example of the technology to construct the network equipped with such NASs is disclosed in JP-A-2005-267233.

It is troublesome for a user of the computer to create a backup of data every time he or she accesses the data. Besides, when the backup data must be saved in the above NAS, it may take much time as a whole to access the data in the NAS. This is because a data access rate of the NAS itself is generally slower than that of the internal storage of a computer, and also because the NAS is connected to the computer via the network.

Therefore, the user is negligent in making the backup of data on account of troublesome, time-consuming operation, and the like.

### SUMMARY

The present invention was made in consideration of the above circumstances, and an object of the present invention is to provide method and apparatus for managing data to improve operability of the user in operating a computer that can select a storage destination of a file from a plurality of drives.

According to a first aspect of the invention, there is provided a method for managing data by a computer capable of selecting a storage destination of a file from a plurality of drives including a first drive and a second drive, said method comprising: editing a target file in the first drive in accordance with an input from a user; listing one or more tasks as unprocessed tasks to be processed on a task list, each of the one or more tasks comprising a content of an edit applied to the target file in association with a name of the target file; and creating a copy of the target file in the second drive by sequentially processing the unprocessed tasks listed on the task list independently of a flow of editing the target file.

According to a second aspect of the invention, there is provided an apparatus for managing data of files stored in a plurality of data storage drives including a first drive and a second drive, the apparatus capable of selecting a storage destination of the file from the plurality of data storage drives, said apparatus for managing data comprising: an editing unit configured to edit a target file in the first drive in accordance with an input from a user; a listing unit configured to list one or more tasks as an unprocessed task to be processed on a task list, each of the one or more tasks comprising a content of an edit applied to the target file in association with a name of the target file; and a backup unit configured to create a copy of the target file in the second drive by sequentially processing the one or more tasks listed on the task list independently of a flow of editing the target file.

According to a third aspect of the invention, there is provided a computer-readable medium having a computer program stored thereon and readable by a computer, said computer program, when executed by the computer, causes the computer to perform operations comprising: editing a target file in a first drive by the computer in accordance with an input from a user; listing one or more tasks as unprocessed tasks to be processed on a task list, each of the one or more tasks comprising a content of an edit applied to the target file in association with a name of the target file; and creating a copy of the target file in a second drive by sequentially processing the one or more tasks listed on the task list independently of a flow of editing the target file.

### BRIEF DESCRIPTION OF THE DRAWINGS

FIG. 1 is a schematic diagram showing a network system according to an embodiment of the present invention;

FIG. 2 is a block diagram schematically showing a hardware configuration of a personal computer (PC) shown in FIG. 1;

FIG. 3 is a block diagram schematically showing a hardware configuration of a Network Attached Storage (NAS) shown in FIG. 1;

FIG. 4 is a flowchart schematically showing an editing program executed in each PC shown in FIG. 1;

FIG. 5 is a view showing an example of a task list made up by the execution of step S5 shown in FIG. 4;

FIG. 6 is a flowchart schematically showing a backup program executed in each PC shown in FIG. 1; and

FIGS. 7A to 7C are views explaining how the contents of the task list are changed when the editing program shown in FIG. 4 and the backup program shown in FIG. 6 are executed.

### DESCRIPTION

One of more illustrative embodiments of the present invention will be explained in detail with reference to the drawings hereinafter.

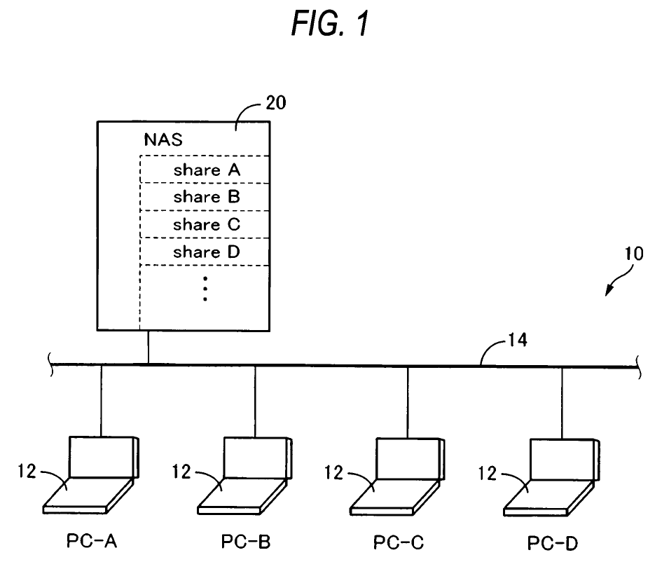

FIG. 1 schematically shows an example of a network system in which a method for managing data according to an embodiment of the present invention can be executed.

In a network system 10, four personal computers (hereinafter referred to as “PCs”) 12 are connected via a wireless or wired network (for example, LAN, WAN, Internet, or the like) to communicate mutually.

The PCs 12 are employed by the user respectively. For convenience of explanation, “PC-A”, “PC-B”, “PC-C”, and “PC-D” denote respective PCs.

One NAS (Network Attached Storage) 20 is connected to a network 14. The NAS 20 is set to be shared with four PCs 12. Therefore, each PC 12 can access the NAS 20.

In this case, the NAS 20 includes a dedicated memory area for each corresponding PC 12. Specifically, the NAS 20 includes four memory areas “share A”, “share B”, “share C”, and “share D”, and the “PC-A”, the “PC-B”, the “PC-C”, and the “PC-D” are allocated to these memory areas, respectively. The memory areas may be allocated in advance.

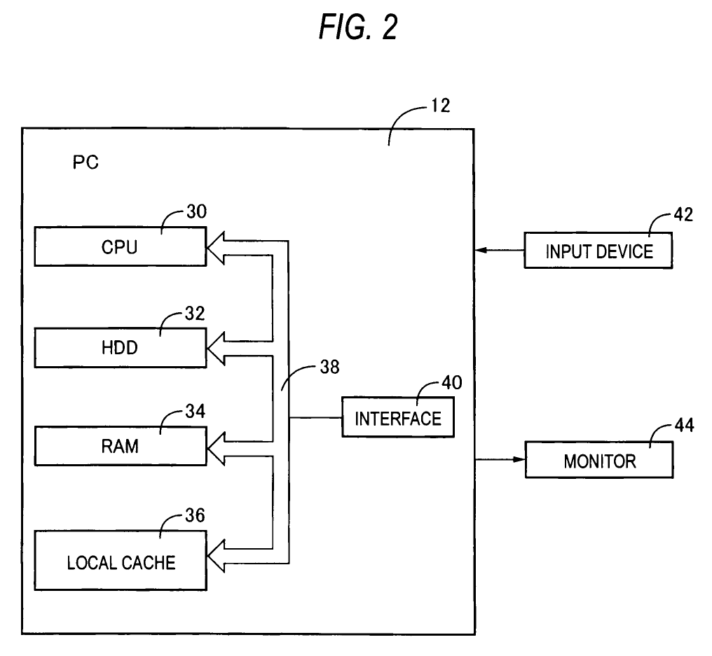

FIG. 2 is a block diagram schematically showing the hardware configuration of a representative one of the four PCs 12. In the PC 12, a CPU (an example of a processor) 30, a hard disk drive (abbreviated as “HDD” hereinafter) 32, a RAM 34, and a local cache 36 are interconnected via a bus 38.

The program to establish an operation system of the PC 12 and various application programs are prestored in the HDD 32. A required program such as an application program can be installed into the HDD 32 by using an external recording medium or by online.

An interface 40 is connected to the bus 38. The PC 12 can be connected to the network 14, peripheral equipments, and/or external devices via the interface 40.

As the peripheral equipments, there are an input device 42 and a monitor 44. The input device 42 includes, for example, a mouse, a key board, and the like to to enable the user to carry out the input operation. The monitor 44 includes a screen to display information visually.

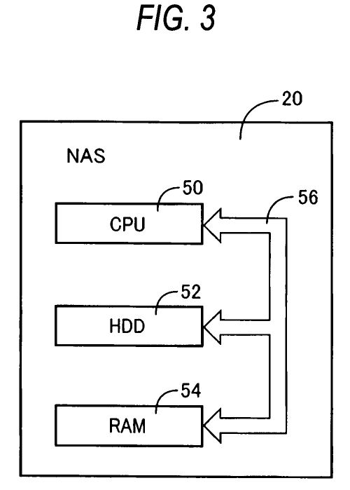

FIG. 3 is a block diagram schematically showing a hardware configuration of the NAS 20.

The NAS 20 includes a CPU 50, a hard disk drive (HDD) 52, and a RAM 54. The CPU 50, the HDD 52, and the RAM 54 are interconnected via a bus 56. Generally, the HDD 52 is a low-speed access drive as compared with the HDD 32. Further, the NAS 20 may include a plurality of HDDs 52.

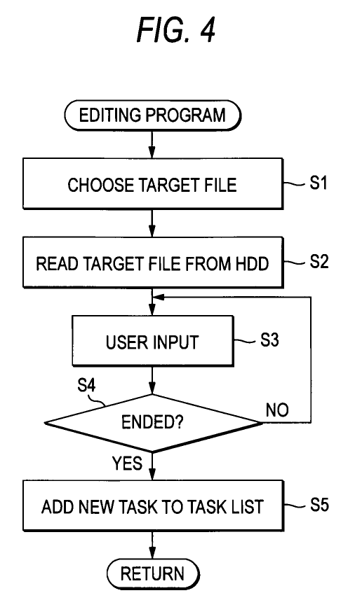

An editing program schematically shown in a flowchart in FIG. 4 is stored in the HDD 32 of each PC 12. The editing program is executed repeatedly by the CPU 30 during operation of each PC 12.

On executing the editing program shown in FIG. 4 every time, in step S1, a file in the HDD 32 (first drive) is chosen as a target file, in accordance with a user's input via the input device 42. When the same file has already been saved in the HDD 32, such file is chosen. In contrast, when the same file does not exist in the HDD 32 yet, this file is newly created in the HDD 32.

Next, in step S2, the target file is read from HDD 32 of the PC 12.

Then, in step S3, the input to edit (e.g., change, delete, or the like) the target file in the HDD 32 is entered by the user via the input device 42. When a series of editing operations applied to the target file is ended (step S4: YES), the process proceeds to step S5. For example, when the user inputs an editing end command (e.g., a command “save”) indicting that a series of editing operations are completed, it is determined that the series of editing operations is ended.

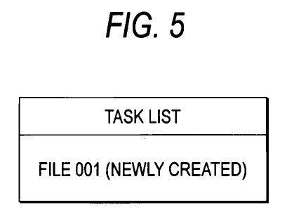

In step S5, the content of the edit applied to the target file is added to a task list as a new task. For example, when the target file is file 001 and this file 001 is the file created newly this time, the name of the file in association with information indicating that this file has been newly created is added to the task list as shown in FIG. 5.

In this case, information to specify a location of a memory area (any one of “share A”, “share B”, “share C”, and “share D”), which is designated in the NAS 20 to save a copy of the target file in the NAS 20 (second drive), is added to the task list.

With the above, one cycle of the execution of the editing program is ended.

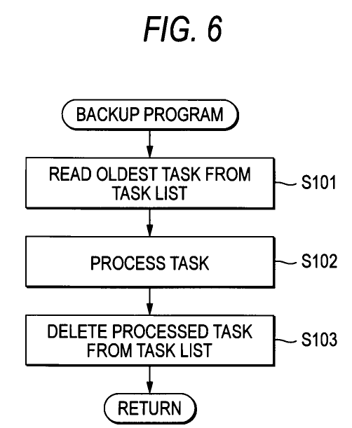

A backup program schematically shown in a flowchart in FIG. 6 is stored in the HDD 32 of each PC 12. The backup program is executed repeatedly during operation of each PC by the CPU 30, independently of an execution timing of the foregoing editing program.

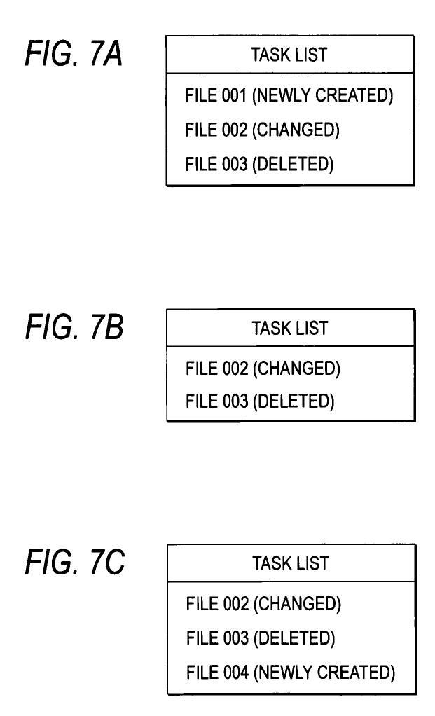

In executing the backup program shown in FIG. 6 each time, in step S101, the oldest task (unprocessed task) is read from the task list. For example, in an example shown in FIG. 7A, a task “file 001 (newly created)” is read as the oldest task.

Then, in step S102, the task that is read is processed. Specifically, the same edit as that applied to the file (file in the HDD 32) of the current task by executing the above editing program is applied to the corresponding file in the corresponding memory area of the NAS 20. As a result, a copy of the file in the HDD 32 is created in the NAS 20, and accordingly, the file in the HDD 32 is backed up.

For example, in the example shown in FIG. 7A, in order to process the task “file 001 (newly created)”, a signal for newly creating a copy of the “file 001” stored in the HDD 32 in the NAS 20 (containing the data indicating the “file 001”) is transmitted to the NAS 20.

In contrast, in the example shown in FIG. 7A, in order to process a task “file 002 (changed)”, a signal for overwriting the existing file in the NAS 20 (the file corresponding to the “file 002”) by the same data as that in the file 002 on the HDD 32 (containing the data indicating the “file 002”) is transmitted to the NAS 20. Accordingly, a copy of the file 002 is created in the NAS 20.

In contrast, in the example shown in FIG. 7A, in order to process a task “file 003 (deleted)”, a signal for deleting the existing file in the NAS 20 (the file corresponding to the “file 003”) is transmitted to the NAS 20.

Then, in step S103, the task that has been processed by executing the process in step S102 is deleted from the task list. For example, in the example shown in FIG. 7A, after the task “file 001 (newly created)” is processed, the processed task is not present in the task list, as shown in FIG. 7B. Thus, the task to be processed next comes to the top of the existing tasks.

Further, when a new task “file 004 (newly created)” occurs thereafter in a state shown in FIG. 7B, this task is added to the bottom of the existing tasks as shown in FIG. 7C.

With the above, one cycle of the execution of the backup program is ended.

According to the present embodiment, in response to the edit (revision) of the target file in the HDD 32 of the PC 12 by executing the above-mentioned editing program, the contents of the edit (revision) are transferred to the backup program through the task list.

The backup program processes sequentially a plurality of tasks, which are listed on the task list in chronological order, in asynchronism with the above editing program. Consequently, a copy of the target file in the HDD 32 of the PC 12 is created in the NAS 20 as a backup copy.

Therefore, according to the present embodiment, individual editing operations are applied not to the HDD 52 of the NAS 20 but to the HDD 32 of the PC 12. As a result, even though a data access rate in the HDD 52 of the NAS 20 is slower than that in the HDD 32 of the PC 12, the data access rate can be improved.

Further, according to the present embodiment, the same data can be saved in the HDD 32 of the PC 12 and the HDD 52 of the NAS 20. As a result, the multiplexing of data can be achieved, and thus a fault tolerance of data can be improved.

According to the embodiment of the invention, the following exemplified aspects can also be obtained.

(1) A method for managing data by a computer capable of selecting a storage destination of a file from a plurality of drives including a first drive and a second drive, said method comprises: editing a target file in the first drive in accordance with an input from a user; listing one or more tasks as unprocessed tasks to be processed on a task list, each of the one or more tasks comprising a content of an edit applied to the target file in association with a name of the target file; and creating a copy of the target file in the second drive by sequentially processing the unprocessed tasks listed on the task list independently of a flow of editing the target file.

(2) The method according to the item (1) may further comprise deleting the task, which has been processed, from the task list.

(3) In the method according to the item (1) or (2), the one or more tasks may be listed on the task list in time series.

An example of editing the target file may include steps S1 to S4 in FIG. 4, an example of listing the task may include step S5 in FIG. 4, an example of creating the copy may include steps S101 and S102 in FIG. 6, and an example of deleting the task may include step S103 in FIG. 6.

Further, an example of the first drive may include the HDD 32 of the PC 12, and an example of the second drive may include the HDD 52 of the NAS 20.

According to this method, the user can create a copy of the target file in the first drive automatically in the second drive, and thus can back up automatically the data.

Further, according to this method, the editing operation of the target file in the first drive is executed independently of the creating operation of a copy of the target file on the second drive. Therefore, even when an access rate of the second drive as the backup destination is slower than that of the first drive, the user can effectively edit the target file in the first drive, irrespective of an access rate of the second drive.

In the present specification, the term “edit” can be interpreted to mean not only partial addition, change, or deletion to an existing file but also all acts applied to change the contents, e.g., creation of a new file, deletion of the existing file, and others.

The computer may be any kinds of the computers, such as a desktop computer (e.g., a personal computer) and a portable computer (e.g., PDA, cellular phone).

(4) In the data managing method according to any of the items (1) to (3), the first drive may be either the internal drive or the external drive of the computer, and the second drive may be either the internal drive or the external drive of the computer.

(5) In the data managing method according to the item (4), the external drive may include at least one of a USB supported storage that is directly connectable to the computer, and an NAS that is capable of communicating with the computer by radio or cable via the network. The USB supported storage may be a USB memory, USB flash, and the like.

(6) In the data managing method according to any of the items (1) to (5), the first drive may comprise a high-speed access storage that allows data reading/writing operations at a first speed, and the second drive may comprise a low-speed access storage that allows data reading/writing operations at a second speed which is slower than the first speed.

(7) In the data managing method according to the item (6), the first drive is an internal drive provided in the computer and the second drive is an external drive of the computer.

(8) A program, when executed by a computer, enables the computer to perform the method in any of the items (1) to (7).

When this program is executed by the computer, the similar advantages can be obtained in accordance with the principle that is basically similar to the method according to any of the items (1) to (7).

The program may include not only a combination of commands executed by the computer to fulfill the function of the program but also files and data processed in accordance with each command.

Further, this program can be formulated to attain a desired object when this program is executed solely by the computer, or attain a desired object when this program is executed along with other programs by the computer. In the latter case, the program according to the present case can be formulated to handle the data mainly.

(9) A computer-readable medium having a program of the item (8) stored thereon.

When the program recorded in this computer-readable medium is executed by the computer, the advantages similar to those in the method according to any one of the items (1) to (7) can be achieved.

Various types of computer-readable medium can be employed as this computer-readable medium. For example, any one of a magnetic recording medium such as a flexible disk, or the like, an optical recording medium such as CD, CD-ROM, or the like, a magneto-optical disc such as MO, or the like, an unremovable storage such as ROM, or the like, and others can be employed.

It may be considered that the editing program shown in FIG. 4 in conjunction with the backup program shown in FIG. 6 configure an example of the “program”, and that the HDD 32 that stores such editing program the backup program configures an example of the “recording medium”.

(10) An apparatus for managing data of files stored in a plurality of data storage drives including a first drive and a second drive, the apparatus capable of selecting a storage destination of the file from the plurality of data storage drives, said apparatus for managing data comprises: an editing unit configured to edit a target file in the first drive in accordance with an input from a user; a listing unit configured to list one or more tasks as an unprocessed task to be processed on a task list, each of the one or more tasks comprising a content of an edit applied to the target file in association with a name of the target file; and a backup unit configured to create a copy of the target file in the second drive by sequentially processing the one or more tasks listed on the task list independently of a flow of editing the target file.

(11) The apparatus according to the item (10) may further comprise an input unit which enables the user of the apparatus to input data to the apparatus.

(12) The apparatus according to the item (10) or (11) may further comprise a deleting unit configured to delete the task, which has been processed by the backup unit, from the task list.

(13) In the apparatus according to any of the items (10) to (12), the one or more tasks may be listed on the task list in time series.

While the present invention has been shown and described with reference to certain exemplary embodiments thereof, it will be understood by those skilled in the art that various changes in form and details may be made therein without departing from the spirit and scope of the invention as defined by the appended claims.

Besides, in the present embodiment, a copy of the most up-to-date version of the target file is created in the NAS 20 in response to the event that a series of latest editing operations applied to the target file in each PC 12 are ended. However, the present invention is not limited thereto, and the most up-to-date version of copy of the target file in each PC 12 may be created periodically in the NAS 20 every time after a predetermined time (e.g., about 5 minute) has elapsed.

In the above-described embodiment, the unprocessed tasks are listed in time series. However, the present invention is not limited thereto, and the unprocessed tasks may be listed in the order according to a given condition based, for example, on a storage destination designated to store the file corresponding to the task, the capacity (or remaining capacity) of the storage destination, or the capacity (size) of the target file.

In the above-described embodiment, the unprocessed tasks are processed subsequently from the top of the task list. However, the present invention is not limited thereto, and the unprocessed tasks may be processed in the order according to a given condition based, for example, on a storage destination designated to store the file corresponding to the task.

In the above-described embodiment, the task having been processed is deleted from the task list, but the present invention is not limited thereto. For example, information indicating that a task has been processed may be added to the corresponding task on the task list, and the PC may select a task not associated with the information as a target for processing the task (as an unprocessed task).

What is claimed is:

1. A method for managing data by a computer capable of selecting a storage destination of a file from a plurality of drives including a first drive and a second drive, said method comprising:
editing a target file in the first drive in accordance with an input from a user;
listing one or more tasks as unprocessed tasks to be processed on a task list, each of the one or more tasks comprising a content of an edit applied to the target file in association with a name of the target file; and
creating a copy of the target file in the second drive by sequentially processing the unprocessed tasks listed on the task list independently of a flow of editing the target file.

2. The method according to claim 1, further comprising deleting the task, which has been processed, from the task list.

3. The method according to claim 1, wherein the one or more tasks are listed on the task list in time series.

4. The method according to claim 1, wherein the second drive comprises at least one of: a USB supported storage device connectable to the computer; and a Network Attached Storage capable of communicating with the computer via a network.

5. The method according to claim 1, wherein the first drive comprises a high-speed access storage that allows data reading/writing operations at a first speed, and the second drive comprises a low-speed access storage that allows data reading/writing operations at a second speed slower than the first speed.

6. The method according to claim 5, wherein the first drive is an internal drive provided in the computer and the second drive is an external drive of the computer.

7. An apparatus for managing data of files stored in a plurality of data storage drives including a first drive and a second drive, the apparatus capable of selecting a storage destination of the file from the plurality of data storage drives, said apparatus for managing data comprising:
an editing unit configured to edit a target file in the first drive in accordance with an input from a user;
a listing unit configured to list one or more tasks as an unprocessed task to be processed on a task list, each of the one or more tasks comprising a content of an edit applied to the target file in association with a name of the target file; and
a backup unit configured to create a copy of the target file in the second drive by sequentially processing the one or more tasks listed on the task list independently of a flow of editing the target file.

8. The apparatus according to claim 7, further comprising an input unit which enables the user of the apparatus to input data to the apparatus.

9. The apparatus according to claim 7, further comprising a deleting unit configured to delete the task, which has been processed by the backup unit, from the task list.

10. The apparatus according to claim 7, wherein the one or more tasks are listed on the task list in time series.

11. A computer-readable medium having a computer program stored thereon and readable by a computer, said computer program, when executed by the computer, causes the computer to perform operations comprising:
editing a target file in a first drive by the computer in accordance with an input from a user;
listing one or more tasks as unprocessed tasks to be processed on a task list, each of the one or more tasks comprising a content of an edit applied to the target file in association with a name of the target file; and
creating a copy of the target file in a second drive by sequentially processing the one or more tasks listed on the task list independently of a flow of editing the target file.
